(19) United States
(12) Patent Application Publication
(10) Pub. No.: US 2025/0057181 A1
(43) Pub. Date: Feb. 20, 2025

(54) MEAT-ALTERNATIVE PRODUCT INCLUDING OILSEED PRESS CAKES

(71) Applicant: MORE ALTERNATIVE FOODS LTD., Tel Aviv (IL)

(72) Inventors: Leonardo MARCOVITZ, Tel Aviv (IL); Florian WILD, Freising (DE)

(21) Appl. No.: 18/708,061

(22) PCT Filed: Nov. 13, 2022
(86) PCT No.: PCT/IL2022/051209

§ 371 Date: May 7, 2024

(30) Foreign Application Priority Data
Nov. 21, 2021 (IL) 288258

(51) Int. Cl. A23J 1/14; A23J 3/20; A23J 3/22; A23J 3/26; A23L 5/10; A23L 25/00; A23L 31/10

(52) U.S. Cl. CPC A23J 1/14; A23J 3/20; A23J 3/227; A23J 3/26; A23L 5/10; A23L 25/30; A23L 31/10

(57) ABSTRACT

A plant and yeast-based meat-alternative product comprising an oilseed press cake, yeast and water wherein the press cake to water ratio is in a range of 3:2 to 1:3, wherein the press cake is obtained from pressing of oil from oilseed of one or more oil producing seed types, wherein at least a portion of the seeds are roasted prior to their de-oiling, and wherein the meat-alternative product contains less than 5% wheat, nuts and/or soy.

### TECHNICAL FIELD OF INVENTION

This disclosure generally relates to an alternative meat product including de-oiled seeds, in particular alternative meat product made of or including oilseed press cakes, more particularly oilseed press cakes made of pumpkin and/or sunflower seeds, pressed into a press cake, which in turn by extrusion generates a fibrous composite featuring meat-like structure and nutritional value.

### BACKGROUND

Due to the growing concerns pertaining to meat supply, unsustainable farming practices, and environmental impact, special attention has been given to developing alternative protein sources for the world population that are readily available, nutritious, and sustainably acquired. Copious amounts (1.3 billion tons) of food waste are produced every year. In recent years, it has become necessary to reduce or recycle food waste by utilizing byproducts of industrial processes for alternative food sources. This is important for (i) reducing the carbon footprint of food production and (ii) ensuring sufficient nutrition for the growing human population.

Recently, plant-based meat substitutes have gained prominence in the world market. These foodstuffs are produced with the aim of achieving taste, texture, mouth-feel, and nutritional value (particularly in protein content) comparable to their animal-based counterparts.

Plant-based meat-alternatives have been developed to resemble cooked muscle meat-like structures resembling chicken breast, with long anisotropic structures. However, high-quality imitations of dark or red meat, such as beef, is yet to be achieved. Furthermore, many plant-based meat substitutes derived from nuts, soy and wheat exhibit properties that are negatively perceived. For example, nuts are major allergen, affecting 1.1% of the general population, barring their use as an alternative source of protein for many people. Additionally, because many soybeans are genetically modified, meat alternatives made from soybeans are often disfavored by consumers. Moreover, even though it remains to be scientifically confirmed, it has been suggested that high levels of isoflavones may result in reproductive difficulties in men as well as elevated estrogen levels in women. Therefore, soy containing foods is often stigmatized as an unwanted ingredient in food stuff. Wheat-derived meat substitutes (i.e., seitan) are primarily composed of gluten, which triggers the autoimmune response in celiac-afflicted individuals (1-2% of the general population). In addition, many consumers try to avoid wheat in their diets for health/diet reasons even without an explicit medical reason to abstain. These factors impede the use of nuts, soybeans and wheat gluten as alternatives to meat.

Oilseed press cakes are solid residues obtained after the extraction of edible oil from oilseeds (such as flaxseed, hemp seed, sunflower seeds, rapeseed, sesame seeds, etc.). These residues have been utilized historically for animal feed and plant fertilizer due to their high protein, carbohydrate, and mineral contents. Due to these nutritional factors, oilseed press cakes are a promising alternative to meat for human consumption.

Yeast is another promising source of protein that might be used in lieu of meat. Proteins obtained from yeast are known for their strong umami taste and are thus widely used as flavor additives in meat-alternatives. However, their inclusion level does not usually exceed 1% w/w in order to enable an overall moderate flavor intensity and a non-dominant yeasty note. Possessing up to 60% w/w protein, a high vitamin content, as well as antioxidants, yeast is a promising alternative to meat.

Therefore, a need exists for alternative meat products that mimic meat (such as beef) with a comparable taste and nutritional index, particularly with respect to protein content. Such composites should be producible at a low cost and enable utility in dishes traditionally prepared with red meat (i.e., steak or strips) and be interchangeable with their animal counterpart in appropriate culinary contexts.

### SUMMARY

There is provided herein, according to some aspects of the disclosure, a meat-alternative product comprising an oilseed press cake, yeast, and water wherein the press cake to water ratio is in a range of 3:2 to 1:3, wherein the press cake is obtained from pressing of oil from oilseed of one or more oil producing seed types, wherein the seeds may be partially roasted and dried prior to their de-oiling or during de-oiling at high temperature.

According to some embodiments, the meat alternative may be produced in a two-step process, the first step may include the generation of the press-cake by continuously pressing the seeds until a less than a 5%-12% oil content is achieved, and a second step may include making a meat alternative by extrusion of the press-cake.

Advantageously, it was found that press cakes or partially or fully defatted expeller from specific oilseeds may be used in a high moisture extrusion process to build-up fibrous, muscle meat-like structures and may serve as a replacement to beef, lamb, pork, turkey, chicken etc. in appropriate culinary applications (i.e., steak or sandwiches). Moreover, it was advantageously found that utilizing the herein disclosed press-cakes or combination of press-cakes, results in a meat alternative product that may serve as an excellent source of protein, vitamins, and antioxidants, comparable to that of meat. This is as opposed to the most alternative meat products, which inter alia due to implementation of protein extraction processes have a reduced content of secondary metabolites, vitamins, fibers, and minerals that are important for a healthy diet.

According to some embodiments, the meat-alternative contains essentially no nuts, soy or wheat. According to some embodiments the meat-alternative may be completely devoid of nuts, soy or wheat. The absence of nuts, wheat and/or soy is of uttermost importance, as non-allergenic protein sources are desired for alternatives to meat products.

According to some embodiments, the primary ingredient of the meat-alternative product may be the often-overlooked pumpkin seeds, which have a low allergenicity and also a high protein content (˜34% w/w) in dried kernels. Surprisingly, partially de-oiled pumpkin flour may be used to create meat like anisotropic structures even when used in low concentrations in combination with ingredients that do not have the ability to form such structures by themselves.

Moreover, while pumpkin seeds have been considered a “no-go” for meat alternative applications due to its unattractive color (green), it was advantageously found by the inventors of the present invention, that if the wet extrudate from pumpkin is cooked, it may almost completely lose the green coloring (at least on its outside), without requiring use of colorants.

Moreover, the herein disclosed meat-alternative product may have a high content of inactivated yeasts. Hitherto, yeast products were not known to form gelled structures, or to resemble fibrous muscle meat-like structures. It was thus surprising that as much as 50% dry base yeast protein may be added to the press cake mixture, while still obtaining a meat like structure. In fact, even an as high inclusion level of dried yeast as 25% w/w of the alternative meat product did not negatively impact the fiber formation, when the remaining plant protein ingredient were from the oilseeds press cakes. Therefore, inactivated yeast, which optionally may be a by-product of beer production, may become a principal component of the alternative meat product and contribute to a unique, smooth mouth-feel of the meat-like structure.

As a further advantage, the meat-alternative product and its production process may be environmentally friendly. This is as compared to, most alternative meat products, which may be based on protein ingredients from soya, pea or wheat, that require an aqueous or aqueous-alcoholic extraction process. That is, these processes require copious amounts of water, heat and electricity—which decreases their cost effectiveness and makes them nonideal as green processes. Additionally, by utilizing the byproduct of the oilseed pressing process, the meat-alternative product may be obtained with minimal resources, which makes their production both economically and environmentally advantageous. Advantageously it was found, that according to some embodiments, the meat alternative may be formulated to contain essentially no protein ingredients manufactured or treated in an aqueous or aqueous-alcoholic extraction process.

According to some embodiments, there may be provided a plant and yeast-based meat-alternative product comprising an oilseed press cake, yeast and water, wherein the press cake to water ratio may be in a range of 3:2 to 1:3, wherein the press cake may be obtained from pressing of oil from oilseed of one or more oil producing seed types, wherein at least a portion of the seeds may be roasted prior to their de-oiling, and wherein the meat-alternative product contains less than 5% wheat, nuts and/or soy.

According to some embodiments, the meat-alternative product may be essentially devoid of wheat, nuts and/or soy. According to some embodiments, the meat-alternative product may be essentially devoid of gluten.

According to some embodiments, the one or more seed types comprises pumpkin seeds. According to some embodiments, the pumpkin seeds constitute about 10-100% w/w of the press cake. According to some embodiments, the pumpkin seeds constitute about 30-80% w/w of the press cake

According to some embodiments, the one or more seed types further comprise sunflower seeds. According to some embodiments, the sunflower seeds constitute about 5-40% w/w of the press cake. According to some embodiments, the sunflower seeds constitute about 10-25% w/w of the press cake

According to some embodiments, the meat-alternative product further includes inactivated yeasts. According to some embodiments, the inactivated yeast comprises 2-30% w/w of the of the press cake.

According to some embodiments, the meat replacement product contains no externally added plant proteins.

According to some embodiments, the meat-alternative product may be comparable to its meat counterpart in natural nutrients (particularly concerning protein content), minerals and antioxidants.

According to some embodiments, the press cake has a fat content of between 5-15% w/w.

According to some embodiments, the meat replacement product's structure may be anisotropic.

According to some embodiments, the meat replacement product may be obtained in a cooking extrusion process which require addition of 40% w/w water or more.

According to some embodiments, at least 25% of the one or more seeds may be partially roasted.

According to some embodiments, a method for producing a meat-alternative product, the method comprising: obtaining a press cake derived from an oil producing seed; wherein at least a portion of the seeds may be partially roasted; adding to the press cake a predetermined amount of inactivated yeast; to obtain a mixture, extruding the mixture using an extruder, thereby obtaining a meat-alternative product having an anisotropic structure.

According to some embodiments, the oil producing seeds comprise pumpkin seeds. According to some embodiments, the pumpkin seeds constitute about 10-100% w/w of the press cake. According to some embodiments, the pumpkin seeds constitute about 30-80% w/w of the press cake.

According to some embodiments, the oil producing seeds further comprise sunflower seeds. According to some embodiments, the sunflower seeds constitute about 5-40% w/w of the press cake. According to some embodiments, the sunflower seeds constitute about 10-25% w/w of the press cake.

According to some embodiments, the inactivated yeast comprises 2-30% w/w of the meat-alternative product. According to some embodiments, the inactivated yeast comprises at least 2% w/w of the meat-alternative product. According to some embodiments, the inactivated yeast comprises at least 3% w/w of the meat-alternative product. According to some embodiments, the inactivated yeast comprises at least 5% w/w of the meat-alternative product. According to some embodiments, the inactivated yeast comprises at least 8% w/w of the meat-alternative product. According to some embodiments, the inactivated yeast comprises at least 10% w/w of the meat-alternative product.

According to some embodiments, more than 20% w/w, more than 30% w/w, or more than 40% w/w water may be added during the extrusion. Each possibility is a separate embodiment.

According to some embodiments, the extrusion may be hot, cooking extrusion.

According to some embodiments, the process further comprises a step of pre-cooking the extruded product, thereby obtaining a meat alternative product having an attractive meat-like color without requiring use of colorants.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 shows the fresh meat-alternative product upon machine production.

FIG. 2 shows the basic form of the meat-alternative product.

FIG. 3 shows the meat-alternative product cut and pulled. Fibrous meat-like structure is apparent.

FIG. 4 shows examples of varied pulled and cut portions of meat-alternative product (clockwise from top left): Strips, patties/minute-steak, cubes, or pulled fragments.

FIG. 5A shows pulled meat-alternative product in a dish upon cooking.

FIG. 5B shows cubed and cooked meat-alternative product as a component in a sandwich.

FIG. 5C shows cut and cooked strips of the meat-alternative product served on a platter with greens and sesame seeds

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

For convenience, certain terms used in the specification, examples, and appended claims are collected here. Unless otherwise defined, all technical and scientific terms used herein have the same meaning as commonly understood by one of ordinary skill in the art to which this invention pertains.

There is provided herein, according to some aspects of the disclosure, a meat-alternative product comprising an oilseed press cake, yeast, and water wherein the press cake to water ratio may be in a range of 3:2 to 1:3, wherein the press cake may be obtained from pressing of oil from partially roasted oilseed of one or more oil producing seed types, wherein at least a portion of the seeds may be roasted prior to their de-oiling, and wherein the meat-alternative product contains no wheat, nuts, or soy.

As used herein, the term “meat-alternative product”, “meat substitute”, “meat replacement”, “alternative-meat” and meat analogue” may be used interchangeably and refer to a meat-like substance made from vegetarian and/or vegan ingredients. Additional common terms include plant-based meat, vegan meat, meat substitute, mock meat, meat-alternative, imitation meat, and vegetarian meat.

As used herein, the term “oilseed” refers to a group of seeds from which oil may be extracted through mechanical pressing. Non-limiting examples of oil producing seeds include sesame, sunflower, canola, rapeseed, pumpkin, flax, poppy seeds, mustard, safflower, hemp, moringa, shea, chia and cotton, as well as oil fruits such as palm and cacao. Each possibility is a separate embodiment.

According to some embodiments, the seeds may be first dehulled to a shell content less than 5 wt %, advantageously less than 2 wt %, advantageously less than 1 wt %, and particularly advantageously <0.1 wt %, and the shells may be separated from the kernel by sieving, sifting and/or sorting. Each possibility is a separate embodiment.

As used herein, the term “press cake” refers to the solid residue obtained after the extraction of oil from an oil seed or a mixture of oilseeds by mechanical pressing. According to some embodiments, the press-cake may be obtained by mechanical de-oiling of the seeds by pressing up to a fat or oil content in the press cake in the range between >5 and <35 wt %, preferably between >6 and <25 wt %, particularly preferably between >7 and <15 wt %. Each possibility may be a separate embodiment. According to some embodiments, water may be removed from the press-cake to obtain a residual water content of less than 10% w/w, less than 7% w/w particularly advantageously less than 5% w/w. Each possibility is a separate embodiment.

As used herein, “partially roasted” refers to a roasting and pressing procedure which results in a less roasted press cake product than that typically used for extraction of oil. According to some embodiments, partial roasting may refer to heating for 10-60 min at 100-170° C. of the roasting pan, preferably 20-40 min at 100-140° C. Preferably the roasting procedure includes permanent gentle stirring to receive homogeneous roasting and moderate thermal treatment within the product. According to some embodiments, the seeds may not be heated to temperatures exceeding 160° C., to temperatures exceeding 130° C., or in a preferred embodiment the temperature does not exceed 120° C.

According to some embodiments, only a small reduction in polyunsaturated fatty acids, such as linoleic acid, may be obtained during roasting. In a preferred embodiment, the reduction may be <5% w/w or <2% w/w of the amount of linoleic acid found in the seed before roasting. Further, according to some embodiments, partial roasting may be conducted in such a way, that Tocopherols (Vitamin E) may be minimally reduced. According to some embodiments, the tocopherols may be reduced by less than 40% w/w, less than 30% w/w, less than 20% w/w, or less than 15% w/w during roasting. Each possibility is a separate embodiment. Additionally, and/or alternatively, mild roasting may allow formation of typical roasted flavor notes such as alkylated pyrazines or 2-acetylpyrrole. Therefore, thermal treatment of the seeds to temperatures>100° C. may preferably applied during roasting. According to some embodiments, the roasting may comprise applying or creating excess heat in the press, thereby minimizing the reduction in linoleic acid and/or other polyunsaturated fatty acids.

According to some embodiments, the press-cake may be grinded into flour. According to some embodiments, the degree of roasting may be characterized by evaluating protein solubility and/or by identifying molecules that may be specifically formed during roasting the seeds, such as but not limited to, flavor compounds or heterocyclic amines (HCAs). According to some embodiments, the degree of roasting may be determined based on oil and water retention capacity, emulsification capacity, gelling capacity, foaming capacity, color or any combination thereof. Each possibility is a separate embodiment.

According to some embodiments, the main parameters influencing the roasting may include:
Maximum temperature of roasting.
The average temperature of roasting.
The duration of roasting.
Mechanical mixing during roasting.
Addition of further ingredients such as salt before/during the roasting.
The slope of the curve for increasing to maximal temperature.
The slope of the curve for decreasing until the end of the process.
The type of roasting oven: convection/conduction/other, etc.
The initial moisture content.
Humidity during roasting.

Surprisingly, by adjusting and tuning/reducing the roasting conditions (e.g., little to no roasting, pressing at moderate temperature, controlling the water content, etc.), extrudates with good structure that have a higher fat content than usual may be obtained. According to some embodiments, the roasting may be sub-optimal vis-à-vis the roasting typically carried out for oil production. According to some embodiments, the roasting may be sub-optimal vis-à-vis the roasting typically carried out for oil production, yet still be enough to ensure adequate/some oil-production, also referred to herein as “mild roasting”. This may advantageously, ensure that the press cake may be a byproduct of oil production. Without being bound by any theory this may probably be because when the ingredient is roasted under certain parameters, it may allow the fat to better bind to the remaining ingredient/s, thus affecting the normal processing of the extrudate. In addition, due to the better binding, the shear needed to produce texture in the extruder may not be impeded.

As used herein, the term “alternative” regarding the meat-alternative product refer to the utility of the product as a foodstuff appropriate, for example as a replacement for beef or other red meat in appropriate culinary contexts.

According to some embodiments, the meat-alternative product may exhibit morphology similar to animal muscle tissue, resulting in a fibrous product, similar to beef steak. According to some embodiments, the meat-alternative product exhibits fibrous anisotropy.

According to some embodiments, the meat-alternative product may contain a similar nutritional value to meat, particularly regarding the therein contained levels of protein, vitamins, and minerals. According to some embodiments, the meat-alternative product may include at least 22% w/w of protein. According to some embodiments, the meat-alternative product may be devoid of or essentially devoid of added mineral components, such as but not limited to iron. According to some embodiments, the meat alternative may contain an inherent amount of 15 mg/kg, 20 mg/kg, 25 mg/kg, 30 mg/kg or more iron (FE). Each possibility is a separate embodiment. According to some embodiments, the meat alternative may contain 100 mg/kg, 150 mg/kg, 175 mg/kg, 190 mg/kg or more of inherent calcium.

As used herein, the denotation “% w/w” refers to weight percent of the subject of the statement relative to the total weight of the meat-alternative product.

According to some embodiments, the meat-alternative product may be pulled, chopped, or diced in a manner similar to beef, and cooked as a direct substitute for meat in a variety of dishes.

According to some embodiments, the meat-alternative product contains 10-100% w/w, 20-100% w/w, 20-90% w/w, 30-90% w/w, 30-80% w/w, 50-80% w/w, 60-80% w/w or any other suitable percentage within the range of 10-100% partially roasted main type of seeds. According to some embodiments, the main type of seeds of the press cake may be, but is not limited to, pumpkin seeds, flaxseeds, chia seeds, hemp seeds, rape seeds, sesame seeds, poppy seeds, mustard seeds, safflower, moringa, shea, cotton, and/or sunflower seeds. Each possibility is a separate embodiment. According to some preferred embodiments, the main seed in the press cake may be pumpkin seeds, optionally partially roasted pumpkin.

According to some embodiments, the meat-alternative product contains 5-15% w/w, 15-25% w/w, 25-35% w/w, 30-40% w/w, 35-40% w/w, or any other suitable percentage within the range of 5-40% w/w of a second type of seeds, such as but not limited to pumpkin seeds, flaxseeds, chia seeds, hemp seeds, rape seeds, sesame seeds, poppy seeds, mustard seeds, safflower, moringa, shea, cotton, and/or sunflower seeds. Each possibility is a separate embodiment. According to some preferred embodiments, the second type of seeds included in the product may be sunflower seeds, optionally partially roasted sunflower seeds.

According to some embodiments, the meat-alternative product may contain 2-20% w/w, 3-17%, 5-15% w/w, 15-25% w/w, 25-30% w/w, or any other suitable percentage within the range of 1-30% w/w yeast. Each possibility is a separate embodiment. According to some embodiments, the yeast may be inactivated. According to some embodiments, the yeast include, but is not limited to any edible yeasts, such as brewer's yeast or baker's yeast. Each possibility is a separate embodiment. Non-limiting examples of suitable yeast strains include Saccharomyces cerevisiae, Streptomyces natalensis, Streptomyces chattanoogensis, Saccharomyces fragilis, Candida utilis, Candida guilliermondii, Candida lipolityca or any combination thereof. Each possibility is a separate embodiment.

Additionally, according to some embodiments, the meat replacement product may not require externally added plant protein e.g., proteins that have been extracted and/or isolated from plant sources. According to some embodiments, the meat-alternative product may be essentially devoid of gluten.

According to some embodiments, the meat-alternative product may contain a fat content of 5-10% w/w, 10-15% w/w, or any other suitable percentage within the range of 5-15% w/w. Each possibility is a separate embodiment.

According to some embodiments, the meat replacement product may have a fat content comparable to beef. According to some embodiments, the meat replacement product may have a fat content of 2-30% w/w, 3-25% w/w or 4-20% w/w. Each possibility is a separate embodiment. According to some embodiments, the meat replacement product may have a fat content of about 8% w/w.

According to some embodiments, the meat-alternative product may contain a protein content of 10-50%, 15-40% w/w, 20-30% w/w, or any other suitable percentage within the range of 25-40% w/w. Each possibility is a separate embodiment. According to some embodiments, the meat replacement product may contain a protein content comparable to beef (about 26% w/w protein).

According to some embodiments, the meat-alternative product may contain minerals in a content exceeding those found in beef. These nutrients may include but are not limited to magnesium (300-600 mg/100 g meat-alternative product vs. 21 mg/100 g beef), potassium (600-1000 mg/100 g meat-alternative product vs. 318 mg/100 g beef), calcium (100-1000 mg/100 g meat replacement product vs. 18 mg/100 g beef), and/or iron (5-40 mg/100 g meat replacement product vs. 2.6 mg/100 g beef). Each possibility is a separate embodiment.

As used herein, the terms “approximately” or “about” in reference to a number are taken to include numbers that fall within a range of ±5% or in the range of ±1% in either direction (greater than or less than) the number unless otherwise stated or otherwise evident from the context (except where such number would exceed 100% of a given value). Where ranges are stated, the endpoints are included within the range unless otherwise stated or otherwise evident from the context.

As used herein, the singular forms “a,” “an” and “the” include plural referents unless the context clearly dictates otherwise.

As used herein, “optional” or “optionally” means that the subsequently described event or circumstance does or does not occur, and that the description includes instances where said event or circumstance occurs and instances where it does not.

As used herein, the term “essentially” may refer to a deviation from a stated amount by ±1%, ±2% or ±5%. Each possibility is a separate embodiment. According to some embodiments, the term “essentially devoid of” may refer to the stated material is either entirely absent or present in a residual amount, such as less than 1%, less than 0.5% or less than 0.1%. Each possibility is a separate embodiment.

As used herein, the term “comprising” is synonymous with the terms “including,” “containing,” or “characterized by,” and is inclusive or open-ended i.e., does not exclude additional, unrecited elements. According to some embodiments, the term comprising may be replaced with the term may be replaced with the term “consisting of” which excludes any element, step, or ingredient not specified in the claim or with the term “consisting essentially of” which limits the scope of a claim to the specified materials or steps “and those that do not materially affect the basic and novel characteristics” of the claimed invention.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

### Example 1.1—Preparation of the Meat-Alternative Product

The herein disclosed meat-alternative product is produced from solid residues of (partially) roasted and pressed oilseeds, some embodiments being composed of pumpkin seed press cakes and/or sunflower seed press cakes, comprising inactive yeast and water. Producing the meat-alternative product entails continuously feeding an cooking extrusion line [ZSK25, Werner & Pfleiderer GmbH, Stuttgart, Germany (now: Coperion GmbH, Stuttgart, Germany), equipped with an chilled cooling channel with dimensions of Width×Height×Length of 50 mm×6 mm×500 mm] with at least 2.0 kg/h pumpkin seed press cake, and a quantity of 1.0 kg/h sunflower press cake/4.1 kg/h water, and in some embodiments a minimum weight of 0.8 kg/h inactivated yeast, whereupon the composite was continuously mixed and sheared, heated to a temperature above 120° C., formed into the slit dimensions and chilled to a temperature below 100° C. during a period of 150 seconds. The resulting strips were cut into 30 cm long pieces and subsequently chilled or frozen until further processing and analysis.

### Example 1.2

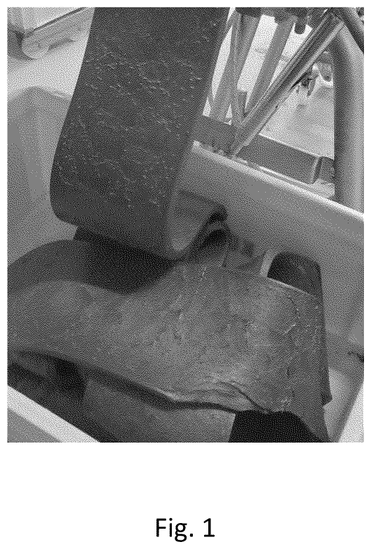

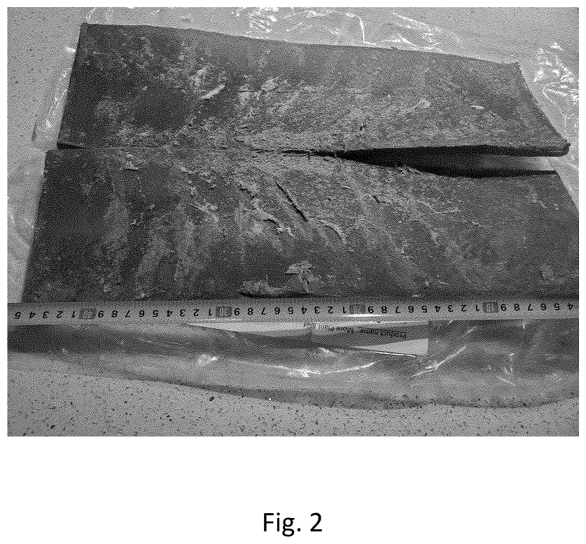

The process was transferred and up-scaled to a larger cooking extrusion line with a total production rate of 150 kg/h. The respectively resulting product was obtained in long strips upon extrusion (FIG. 1), which were then cut into 50 cm pieces (FIG. 2) for handling.

### Example 2—Structure and Handling of Meat-Alternative Product

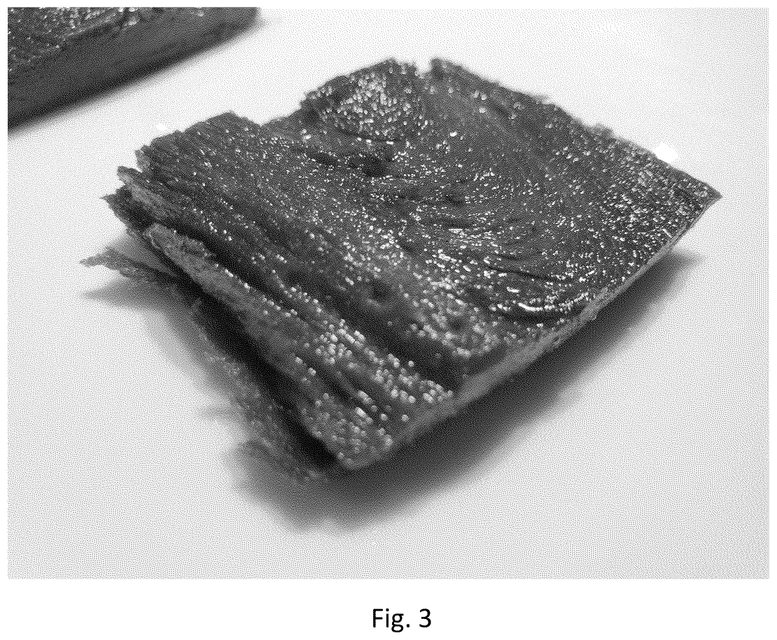

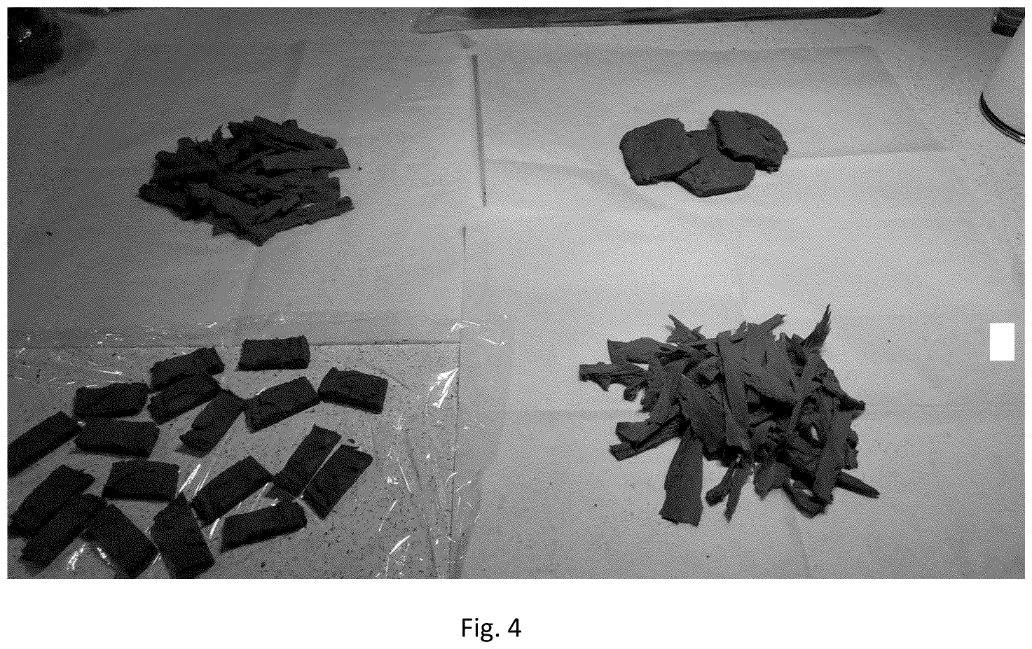

The meat-alternative product exhibited fibrous anisotropy similar to animal muscle, i.e., minute steak (FIG. 3). Upon initial cutting and/or pulling from production, the meat-alternative product could be further cut into minced meat, strips, patties, cubes (FIG. 4) or any other shape that can be stamped, cut, ripped or divided from a continuously released extrusion. This flexibility of utility enables use in a variety of dishes, especially as a meat substitute (vide infra) but also as a stand-alone new food product. Adding further ingredients prior, during or post extrusion, such as, but not limited to, flavors, spices, spicing marinates, odor agents, colorants, umami, salty or sweet components such as salt or sugar, or fatty components can modify appearance and taste perception widely.

### Example 3—Cooking and Serving the Meat-Alternative Product

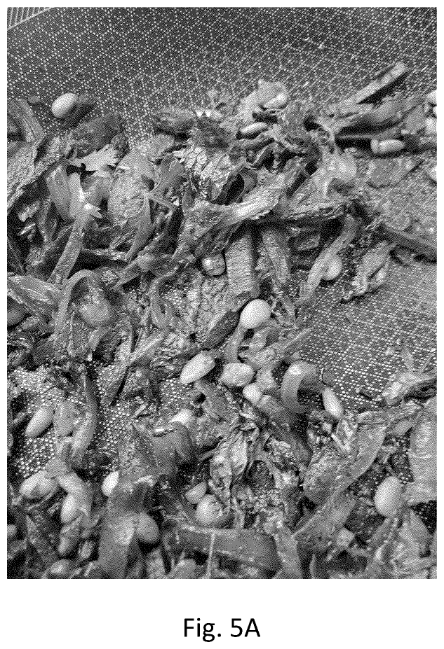

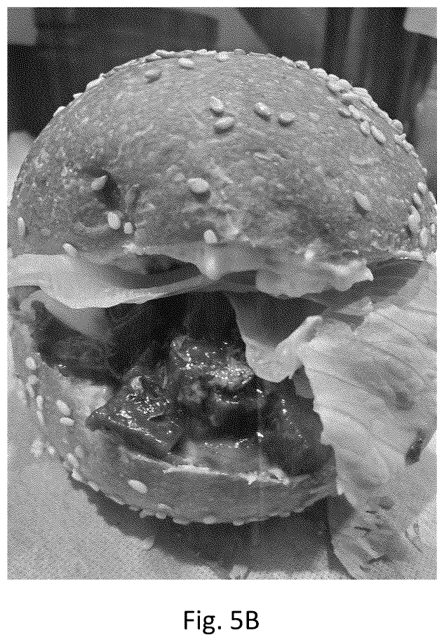

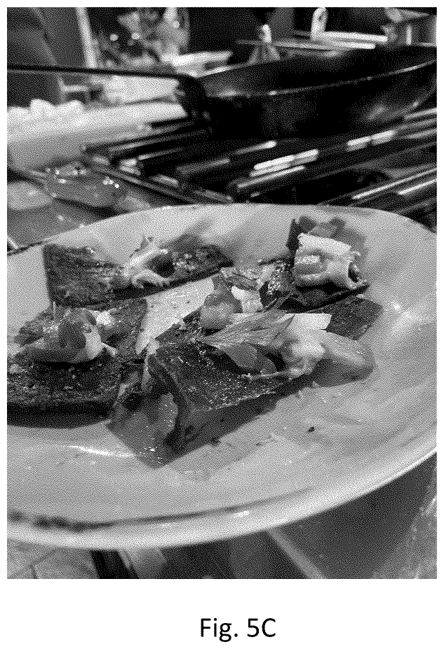

It was demonstrated that upon appropriate preparation (i.e., appropriate cutting, dicing, or pulling) following machine production, that the meat replacement product was useful, in some embodiments, as a substitute for meat in the following contexts: (i) pulled and cooked in a stir-fry dish (FIG. 5A), (ii) cubed and added to a sandwich (FIG. 5B), and (iii) cut into thin sheets and served with a garnish (FIG. 5C).

While a number of exemplary aspects and embodiments have been discussed above, those of skill in the art will recognize certain modifications, additions, and sub-combinations thereof. It is therefore intended that the following appended claims and claims hereafter introduced be interpreted to include all such modifications, additions, and sub-combinations as are within their true spirit and scope.

1.-25. (canceled)

26. A plant and yeast-based meat-alternative product comprising:
an oilseed press cake;
inactivated yeast; and
water,
wherein the press cake to water ratio is in a range of 3:2 to 1:3,
wherein the inactivated yeast comprises at least about 2% w/w of the meat-alternative product,
wherein the press cake is obtained from pressing of oil from oilseed of one or more oil producing seed types,
wherein at least a portion of the seeds are roasted prior to their de-oiling, and
wherein the meat-alternative product is essentially devoid of wheat, nuts and/or soy.

27. The meat-alternative product of claim 26, wherein the meat-alternative product is essentially devoid of gluten.

28. The meat-alternative product of claim 26, wherein the one or more seed types comprises pumpkin seeds.

29. The meat-alternative product of claim 28, wherein the pumpkin seeds constitute about 30-80% w/w of the press cake.

30. The meat-alternative product of claim 26, wherein the one or more seed types further comprise sunflower seeds.

31. The meat-alternative product of claim 30, wherein the sunflower seeds constitute about 5-40% w/w of the press cake.

32. The meat-alternative product of claim 26, wherein the inactivated yeast is selected from Saccharomyces cerevisiae, Streptomyces natalensis, Streptomyces chattanoogensis, Saccharomyces fragilis, Candida utilis, Candida guilliermondii, Candida lipolityca or any combination thereof.

33. The meat replacement product of claim 26, wherein the press cake has a fat content of between 5-15% w/w.

34. The meat replacement product of claim 26, wherein the meat replacement product's structure is anisotropic.

35. The meat replacement product of claim 26, wherein at least 25% of the one or more seeds are partially roasted.

36. A method for producing a meat-alternative product, the method comprising:
obtaining a press cake derived from an oil producing seed, wherein at least a portion of the seeds are partially roasted at a temperature of at least 100° C.;
adding to the press cake a predetermined amount of inactivated yeast to obtain a mixture; and
extruding the mixture using an extruder, wherein more than 40% w/w water is added during the extruding, thereby obtaining a meat-alternative product having an anisotropic structure.

37. The method of claim 36, wherein the oil producing seeds comprise pumpkin seeds.

38. The method of claim 37, wherein the pumpkin seeds constitute about 30-80% w/w of the press cake.

39. The method of claim 36, wherein the oil producing seeds further comprise sunflower seeds.

40. The method of claim 39, wherein the sunflower seeds constitute about 5-40% w/w of the press cake.

41. The method of claim 40, wherein the sunflower seeds constitute about 10-25% w/w of the press cake.

42. The method of claim 36, wherein the inactivated yeast comprises 5-30% w/w of the of the press cake.

43. The method of claim 36, wherein the extrusion is hot, cooking extrusion.

44. The method of claim 36, further comprising a step of pre-cooking the extruded meat-alternative product.
